(19) United States
(12) Patent Application Publication
(10) Pub. No.: US 2026/0198409 A1
(43) Pub. Date: Jul. 16, 2026

(54) HYDROGEL MATERIALS

(71) Applicant: Khalifa University of Science and Technology, Abu Dhabi (AE)

(72) Inventors: Linda Yuan Zou, Abu Dhabi (AE); Adetunji Alabi, Abu Dhabi (AE); Ahmed Mamdouh Aboulella, Abu Dhabi (AE)

(21) Appl. No.: 19/018,126

(22) Filed: Jan. 13, 2025

(51) Int. Cl. A01C 23/04; B01J 13/00; C02F 1/44

(52) U.S. Cl. CPC A01C 23/042; B01J 13/0065; C02F 1/445

(57) ABSTRACT

A system for fertigation includes a forward osmosis membrane capable of receiving a feed stream including water and at least partially rejecting one or more substances to form a purified stream; and a hydrogel material capable of receiving the purified stream and forming a fertigation product stream, wherein the hydrogel material includes an alginate component, a polymeric matrix, and a graphene oxide material.

### TECHNICAL FIELD

The subject matter disclosed herein relates to hydrogel materials and more particularly to hydrogel materials for fluid treatment, water utilization, and fertigation. The subject matter disclosed herein further relates to methods for forming such hydrogel materials.

### BACKGROUND

Hydrogels can include synthetic or natural materials including polymer chains that are cross-linked by either physical or chemical bonds, forming a three-dimensional polymeric matrix of polymer chains. The polymer chains in the hydrogel can provide structural integrity and can prevent the hydrogel from breaking down in aqueous environments. Hydrogels can absorb and retain significant amounts of water, conventionally due to the high concentration of hydrophilic groups present in the polymer chains. For example, hydrogels can be useful in numerous applications, such as tissue engineering and regenerative medicine, drug delivery, biosensors, food industries, and water treatment applications.

Fertigation is an innovative agricultural technique that combines fertilization and irrigation by delivering fertilizers to crops through irrigation systems, such as drip irrigation. This irrigation method allows farmers to apply water-soluble nutrients precisely where and when plants need them, resulting in improved crop yields, reduced fertilizer waste, and minimized environmental pollution. Fertigation can conventionally utilize a water stream and a concentrated fertilizer solution. Managing two separate liquid streams (i.e., the feed water and the concentrated fertilizer solution) can be logistically complex and impractical for large-scale agricultural operations. Additionally, the need for specialized equipment to handle and maintain these solutions can increase operational costs and complicate field applications. For efficient use of water, it is desirable to use groundwater, but groundwater can exhibit an undesirable hardness and/or salinity. Therefore, it would be beneficial to provide hydrogel materials and systems for fertigation, such as hydrogel materials capable of drawing and treating water in fertigation applications.

### SUMMARY

According to one aspect, a system for fertigation includes a forward osmosis membrane capable of receiving a feed stream including water and at least partially rejecting one or more substances to form a purified stream; and a hydrogel material capable of receiving the purified stream and forming a fertigation product stream, wherein the hydrogel material includes an alginate component, a polymeric matrix, and a graphene oxide material.

According to another aspect, a method for fertigation includes adding a fertilizer to a hydrogel material, wherein the hydrogel material includes an alginate component, a polymeric matrix, and a graphene oxide material; and transferring a liquid through the hydrogel material to form a liquid product stream, wherein the liquid product stream includes at least a portion of the fertilizer.

According to another aspect, a method for forming a hydrogel includes mixing an alginate component, a hydrophilic monomer component, a cross-linking agent, an initiator, and a graphene oxide material sufficient for polymerization of the hydrophilic monomer component to form a hydrogel material.

### BRIEF DESCRIPTION OF THE DRAWINGS

FIG. 1 illustrates a method for forming a hydrogel, according to some embodiments.

FIG. 2A illustrates a method for fertigation, according to some embodiments.

FIG. 2B illustrates a system for fertigation, according to some embodiments.

FIG. 3 illustrates a method for forming a hydrogel, according to some embodiments.

FIG. 4 illustrates a method for purification, according to some embodiments.

FIG. 5 illustrates an example method for forming a hydrogel, according to some embodiments.

FIG. 6A illustrates a scanning electron microscope (SEM) image of a PAG hydrogel, according to some embodiments.

FIG. 6B illustrates a scanning electron microscope (SEM) image of a PAG hydrogel, according to some embodiments.

FIG. 7 illustrates an example fertigation test, according to some embodiments.

FIG. 8A illustrates PAG hydrogel performance in terms of water flux, according to some embodiments.

FIG. 8B illustrates PAG hydrogel performance in terms of water flux, according to some embodiments.

FIG. 9A illustrates a scanning electron microscope (SEM) image of a P hydrogel bead, according to some embodiments.

FIG. 9B illustrates a scanning electron microscope (SEM) image of a cross-section of a P hydrogel bead, according to some embodiments.

FIG. 9C illustrates a scanning electron microscope (SEM) image of a cross-section of a P hydrogel bead, according to some embodiments.

FIG. 9D illustrates a scanning electron microscope (SEM) image of a GM hydrogel bead, according to some embodiments.

FIG. 9E illustrates a scanning electron microscope (SEM) image of a cross-section of a GM hydrogel bead, according to some embodiments.

FIG. 9F illustrates a scanning electron microscope (SEM) image of a cross-section of a GM hydrogel bead, according to some embodiments.

FIG. 10 illustrates an example heavy metal removal method, according to some embodiments.

FIG. 11A illustrates heavy metal removal results for P hydrogel and GM hydrogel beads based on percent copper adsorption, according to some embodiments.

FIG. 11B illustrates heavy metal removal results for P hydrogel and GM hydrogel beads based on equilibrium copper adsorption, according to some embodiments.

FIG. 11C illustrates heavy metal removal results for P hydrogel and GM hydrogel beads based on percent nickel adsorption, according to some embodiments.

FIG. 11D illustrates heavy metal removal results for P hydrogel and GM hydrogel beads based on equilibrium nickel adsorption, according to some embodiments.

### DETAILED DESCRIPTION

Embodiments of the present disclosure provide hydrogel materials, methods for forming such materials, and systems and methods including utilization of hydrogel materials. Hydrogels of the present disclosure can include a three-dimensional polymeric matrix structure. In one example, hydrogels of the present disclosure include hydrophilic polymers. Hydrogels of the present disclosure can be formed by chemical or physical crosslinking. For example, hydrogels formed by chemical crosslinking can provide excellent gel properties, stability, and strong mechanical capacity through covalent bonds with the addition of crosslinking agents. Hydrogels of the present disclosure can be used for fluid treatment applications, such as water purification. In one example, hydrogels of the present disclosure can be used in a forward osmosis system. For example, these hydrogels can be used in fertigation applications as non-liquid draw agents.

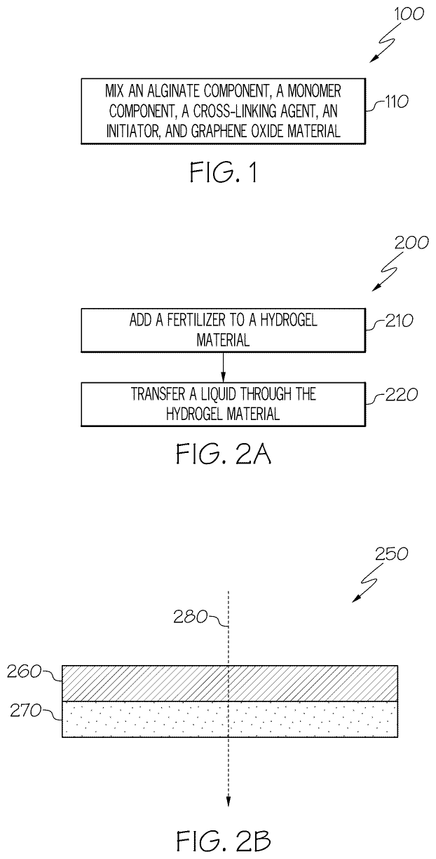

FIG. 1 illustrates a method for forming a hydrogel, according to some embodiments. Method 100 includes Step 110. Step 110 includes mixing an alginate component, a monomer component, a cross-linking agent, an initiator, and a graphene oxide material.

Referring to Step 110, an alginate component, a monomer component, a cross-linking agent, an initiator, and a graphene oxide material are mixed. The mixing can be sufficient to form a hydrogel material. The mixing can be sufficient for polymerization of the monomer component to form a hydrogel material. The alginate component, monomer component, cross-linking agent, initiator, and graphene oxide material can be mixed in various orders. In one example, the alginate component, monomer component, cross-linking agent, initiator, and graphene oxide material are mixed simultaneously. Mixing can include contacting, stirring, dissolving, dispersing, and/or heating.

The alginate component can include alginate, such as alginate-based plant oils or extracts. Alginate includes alginic acid, derivatives of alginic acid, and/or salts of alginic acid. Alginic acid is a linear polymer including L-glucuronic acid and D-mannuronic acid residues connected via 1,4-glycosidic linkages. Alginate can be extracted from seaweed. For example, alginate can include a water-soluble polysaccharide extracted from brown algae-cell walls. The derivative of alginic acid can include one or more modified forms of alginic acid (e.g., chemically altered structure, such as esterified alginates). Examples of alginate salts include sodium alginate, potassium alginate, and calcium alginate. In one example, the alginate component includes one or more of alginate, sodium foam of alginate, and sodium alginate. In another example, the alginate component is sodium alginate ((C₆H₇NaO₆)ₙ, where n is 1 or greater). A chemical structure for sodium alginate is shown below.

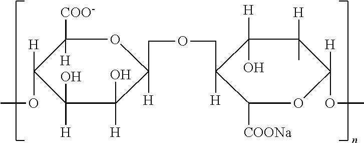

Sodium alginate can include the sodium salt of alginic acid. Sodium alginate can be extracted from cell walls of brown algae. The alginate component can be prepared in the form of a mixture with water (e.g., sufficient to form a solution). For example, sodium alginate can be prepared in the form of a sodium alginate solution. The alginate content within the hydrogel can provide a gel skeleton to the hydrogel material, which can hold a high water content.

A sodium alginate solution may be prepared by mixing (e.g., sufficient for dissolving) sodium alginate solid material (e.g., powder) in deionized water. In one example, the concentration of sodium alginate in the sodium alginate solution ranges from about 0.5% w/v to about 10% w/v. In another example, the concentration of sodium alginate in the sodium alginate solution ranges from about 0.75% w/v to about 4% w/v. In yet another example, the concentration of sodium alginate in the sodium alginate solution is about 1% w/v. The concentration of sodium alginate in the sodium alginate solution may be increased or decreased to sufficiently form the first solution. For example, 0.5 g to 5 g, or 1 g to 5 g, of sodium alginate can be dissolved (at least partially) in 50 mL to 150 mL of water. In one non-limiting example, 0.5 g to 3 g of sodium alginate is dissolved in 100 mL of water, promoting a mechanically stable formed hydrogel. The mechanically stable hydrogel can withstand the weight of the feed without collapsing. In one example, 1 g to 3 g of sodium alginate can be dissolved (at least partially) in 100 mL of water. Water can be in the form of deionized water. The sodium alginate can be mixed with water for 1 minute to 1 hour. Other alginate forms (e.g., calcium alginate) can be prepared in concentration ranges mentioned for sodium alginate in the present disclosure.

The monomer component can include a plurality of monomers. The monomer component includes monomers capable of forming a three-dimensional network of polymers. The monomer component can be a hydrophilic monomer component. Accordingly, the hydrophilic monomer component can include a plurality of hydrophilic monomers capable of enhancing the hydrophilicity of the formed hydrogel. In one example, the hydrophilic monomer component includes monomers capable of forming polyacrylic acid (PAA). In one example, the hydrophilic monomer component includes acrylic acid. Acrylic acid can be utilized to form a hydrogel material including polyacrylic acid. The monomer component can be mixed with the alginate component. In one example, the monomer component can be present in the form of a solution. For example, the monomer component can be added to the formed alginate-containing solution (e.g., sodium alginate solution). The monomer component and formed alginate-containing solution can be mixed for 1 minute to 1 hour. In one example, about 5 mL to about 15 mL of the monomer component is added to the alginate component. In another example, about 5 mL to about 10 mL of the monomer component is added to the alginate component.

The graphene oxide material can include graphene materials of various forms, such as graphene oxide-containing nanomaterials. The graphene oxide material includes oxygen containing groups. Alternatively, or additionally, non-oxide forms of graphene or graphene containing-compounds can be utilized. The graphene oxide nanomaterial can include at least one of graphene oxide nanoparticles and graphene oxide nanosheets. Graphene oxide nanosheets include a two-dimensional carbon structure with oxygen-containing functional groups.

In one example, graphene oxide can be in the form of a graphene oxide dispersion in water. Graphene oxide nanoparticles and/or nanosheets may be utilized due to the hydrophilic nature of the nanomaterial and the ease of dispersing the nanomaterial in an aqueous medium. Graphene oxide nanosheets can increase the hydrophilic functional sites and increase the connectivity of the formed hydrogel. Graphene oxide can alter the polymeric chain orientation and packing. In one example, utilizing graphene oxide nanosheets can provide improved structured channels for water flow. Importantly, these graphene oxide nanosheets can enhance the water draw efficiency without substantially compromising the physical strength of the formed hydrogel material. Graphene oxide (e.g., graphene oxide nanosheets in a dispersion) can be added at various steps of the formation process (e.g., after the monomer component and alginate component have been mixed for a period of time).

Graphene oxide can be prepared using a modified Hummers method. In one example, sulfuric acid can be cooled, and graphite flakes and sodium nitrate can be added to the cooled sulfuric acid to form a solution. After, potassium permanganate can be added to the solution. The solution can be stirred and transferred to an ice bath. After, deionized water can be added, and the solution can be stirred at room temperature. Then, deionized water can be added to the solution followed by the dropwise addition of hydrogen peroxide. The solution can be vacuum filtered and washed, and the recovered graphite oxide cake may be washed with hydrochloric acid solution and vacuum filtered again. The mud can then be washed with deionized water until the pH rises. Finally, the graphite oxide may be diluted with deionized water and exfoliated with an ultrasonicator to produce graphene oxide nanosheets. In one example, about 1 mL to about 10 mL of a graphene oxide dispersion is added, where the graphene oxide dispersion has a concentration of graphene oxide ranging from about 1 mg/mL to about 5 mg/mL. In another example, about 1 mL to about 5 mL of a graphene oxide dispersion is added, where the graphene oxide dispersion has a concentration of graphene oxide of about 2 mg/mL. Graphene oxide materials for use in the present disclosure can be obtained (already prepared) in the form of a suspension and/or powder.

The cross-linking agent can include one or more crosslinkers. The cross-linking agent includes a component capable of chemically bonding different molecules or monomers together. In one example, the cross-linking agent includes a covalent crosslinker. The covalent crosslinker can be a bifunctional crosslinker. Bifunctional crosslinkers can include two or more reactive ends that can chemically bond different molecules or monomers together. In one example, the bifunctional crosslinker includes N,N-methylene bisacrylamide (MBA). MBA can promote formation of covalent bonds between polymer chains via two reactive double bonds. The MBA can act as a bridge between polymer chains, creating a more robust hydrogel by crosslinking when activated by an initiator. Other examples of cross-linking agents include carbodiimide compounds. In one example, the cross-linking agent is added after the graphene oxide material is mixed with the monomer component and the alginate component. The cross-linking agent can be added simultaneously with the initiator.

The initiator includes an element or compound capable of at least partially initiating the polymerization reaction. The initiator can include one or more free radical initiators. Free radical initiators can generate free radicals to start the polymerization process, promoting the cross-linking agent to crosslink polymer chains. In one example, the free radical initiator includes at least one of ammonium persulfate (APS), potassium persulfate (KPS), and sodium persulfate. In another example, the free radical initiator is APS. The ratio of cross-linker to initiator can be altered to change one or more properties of the formed hydrogel. In one example, the weight ratio of the cross-linking agent to the initiator ranges from about 0.5:1 to about 3:1. In another example, the weight ratio of the cross-linking agent to the initiator ranges from about 1.1:1 to about 2.5:1. In another example, the weight ratio of the cross-linking agent to the initiator ranges from about 1.5:1 to about 2.5:1. In another example, the weight ratio of the cross-linking agent to the initiator ranges from about 1.8:1 to about 2.2:1. The amount (e.g., by weight) of the cross-linking agent can be greater than the amount of the initiator. Ratios of the cross-linking agent to the initiator of the present paragraph can promote desirable water production and material strength.

During, and/or after mixing, the mixture can be heated. In one example, heating can be utilized to promote desirable polymerization conditions or to at least partially solidify the mixture. For example, the mixture is heated after being stirred for a time period. In one example, the mixture is heated at a temperature of greater than 40° C. In another example, the mixture is heated at a temperature of greater than 50° C. In another example, the mixture is heated at a temperature of greater than 60° C. The mixture can be heated at a temperature ranging from about 55° C. to about 100° C., The mixture can be heated at a temperature ranging from about 60° C. to about 80° C. The mixture can be heated at a temperature ranging from about 65° C. to about 80° C. The mixture can be heated at a temperature of the present disclosure for a time period sufficient to form the hydrogel product material. The hydrogel product material can be rinsed with a liquid (e.g., water) to remove unreacted excess materials, After the synthesis process, the hydrogel can be freeze-dried below −30° C. for a time period to expel some water from the polymeric matrix.

The hydrogel product material can include a polymeric matrix, graphene oxide, and an alginate component. The polymeric matrix includes a three-dimensional matrix, including polymeric material, capable of holding or surrounding other materials, such as graphene oxide. In one example, the hydrogel product material includes polyacrylic acid polymers, graphene oxide nanosheets, and sodium alginate. The hydrogel product material can be infused with a fertilizer to form a fertilizer infused superhydrophilic graphene oxide-alginate-polyacrylic acid hydrogel.

FIG. 2A illustrates a method for fertigation, according to some embodiments. Method 200 includes at least one of Step 210 and Step 220. Method 200 can include adding (e.g., contacting) one or more fertilizers to the hydrogel material. One or more fertilizers can be infused into (e.g., within at least a portion of) the hydrogel material. For example, the hydrogel material can be formed by method 100.

Referring to Step 210, a fertilizer is added to a hydrogel material. For example, one or more fertilizers can be infused, injected, or otherwise placed within at least a portion of the hydrogel material, One or more fertilizer-containing liquids can be placed in contact with the hydrogel material. In one example, one or more fertilizers can be in contact with an outer surface of the hydrogel material. Infusing can include immersing the hydrogel material in a fertilizer-containing liquid. For example, the fertilizer can be infused within the hydrogel material by immersing the hydrogel material in a fertilizer-containing solution sufficient for the hydrogel material to absorb the fertilizer. This can increase the osmotic pressure sufficient to draw more water. Accordingly, the hydrogel material can be infused to form a fertilizer-infused hydrogel.

The fertilizer includes a substance, including an element and/or compound, capable of improving plant growth and/or health. The fertilizer can include one or more elements and/or compounds capable of supplying nutrients to an environment or organism, such as soil and/or plants. For example, the fertilizer can provide macronutrients to soil and/or plants, such as nitrogen, phosphorus, and potassium. In addition to these macronutrients, fertilizers can also provide nutrients (e.g., calcium, magnesium, and sulfur) and micronutrients (e.g., iron, manganese, and zinc) that can promote overall plant health. Fertilizers can improve crop yields, restore soil fertility, and/or enhance plant health. The fertilizer can include a substance for preventing or reducing plant disease. Fertigation can include a combination of irrigation and fertilization. Fertigation can provide at least one of improved nutrient-use efficiency, enhanced water-use efficiency, increased crop yields and quality, and reduced fertilizer waste and environmental pollution.

The fertilizer can include one or more water-soluble fertilizers. The water-soluble fertilizer can be substantially dissolved or dispersed in water. Since the fertilizer can include one or more water-soluble fertilizers, the fertilizer can be at least substantially dissolved in water to generate osmotic pressure. The fertilizer can include an inorganic fertilizer. The inorganic fertilizer can include an alkali metal salt. In one example, the fertilizer includes at least one of a nitrogen-based fertilizer, a calcium-based fertilizer, a phosphorus-based fertilizer, and a potassium-based fertilizer. In another example, the inorganic fertilizer includes at least one of urea, ammonium nitrate, ammonium chloride, ammonium sulfate, calcium nitrate, diammonium phosphate, monoammonium phosphate, triple superphosphate, potassium nitrate, and potassium chloride. In another example, the inorganic fertilizer includes at least one of potassium chloride and ammonium chloride. In one non-limiting example, the fertilizer includes a water-soluble potassium-based fertilizer. Examples of water-soluble potassium-based fertilizers include potassium nitrate and potassium chloride. The fertilizer can include a water-soluble potassium-based fertilizer and one or more additional fertilizers of the present disclosure.

The hydrogel material can be immersed (e.g., completely immersed) in the one or more fertilizers (e.g., fertilizer-containing liquids). The fertilizer can be infused, injected, or otherwise transferred into the entire hydrogel material. The bulk of the hydrogel can be absorbed with fertilizer within the material layer. The hydrogel material can be placed in contact with a fertilizer-containing liquid by immersing the entire hydrogel material in the fertilizer-containing liquid to transfer the fertilizer into the hydrogel material. For example, the hydrogel material may be soaked in a fertilizer-containing liquid (e.g., fertilizer solution) for 1 hour to 10 hours. In one example, the hydrogel material may be soaked in a fertilizer-containing liquid (e.g., fertilizer solution) for 2 hours to 8 hours. In one non-limiting example, the hydrogel material is soaked in a potassium chloride solution,

Referring to Step 220, a liquid is transferred through (e.g., absorbed by) a hydrogel material. The liquid can be transferred through the hydrogel material sufficient for the liquid to exit the hydrogel material as a product stream. For example, fertigation can combine fertilization and irrigation to deliver fertilizer to soil and/or plants. Alternatively, or additionally, liquid can be transferred adjacent to the hydrogel material, sufficient to flow past an outer surface of the hydrogel material. The hydrogel material can include one or more hydrogel materials of the present disclosure. For example, the hydrogel material can be formed by method 100. The hydrogel material can include a polyacrylic acid matrix and graphene oxide nanosheets. The liquid can include one or more liquids sufficient for irrigating and/or fertilizing plants. In one example, the liquid includes water. The water can be obtained from various sources, such streams, groundwater, rivers, and lakes. In one example, water includes at least partially salinated water, such as groundwater and seawater. For example, the water can have a salinity level above 100 mg/L. For example, the water can have a salinity level above 1000 mg/L.

The hydrogel material can promote drawing liquid across a membrane. For example, the hydrogel material can promote drawing liquid across a forward osmosis membrane. Therefore, method 200 can include drawing the liquid across a forward osmosis membrane material prior to transferring the liquid through and/or past the hydrogel material. The hydrogel material can be placed adjacent to the forward osmosis membrane. In one example, the hydrogel material is in contact with at least a portion of the forward osmosis membrane. The hydrogel material can draw water, at least in part due to an osmotic gradient between the hydrogel material and the liquid. In one example, the forward osmosis membrane includes a cellulose-based membrane. The cellulose-based membrane can include cellulose triacetate. The cellulose triacetate can be supported on polyester screen mesh. In another example, the forward osmosis membrane includes a thin film composite (TFC) membrane. The TFC membrane can include a thin polyamide layer on a porous support.

Since the fertilizer can include a salt compound, the fertilizer can provide an increased osmotic potential to the hydrogel material, sufficient to increase the osmotic potential gradient between water and the hydrogel material. By transferring liquid through the hydrogel material, at least some of the fertilizer can transfer to the liquid to form a product liquid stream. The hydrogel material is sufficient to allow for gradual leeching of the fertilizer to the liquid, to provide a product liquid stream with desirable concentrations of fertilizer for plant applications. The concentration of fertilizer in the product liquid stream can be tuned to a desirable concentration for safe fertilization of plants. In one example, the concentration of potassium-based fertilizer in the product liquid stream ranges from about 0.001M to about 0.2M. In one example, the concentration of potassium chloride fertilizer in the product liquid stream ranges from about 0.002M to about 0.2M, The hydrogel material can be regenerated by adding additional fertilizer to the hydrogel material. Compared to using energy-intensive stimuli to recover absorbed water in hydrogels or complicated liquid-liquid separation processes, the fertilizer can be efficiently added to the liquid for fertigation. Further, the hydrogel material can reduce water hardness by effectively removing at least one of calcium ions and magnesium ions. Additionally, or alternatively, the hydrogel material can remove sodium ions from the liquid stream.

FIG. 2B illustrates a system for fertigation, according to some embodiments, System 250 can include membrane 260 and hydrogel material 270. In one example, membrane 260 includes a forward osmosis membrane suitable for forward osmosis. Membrane 260 can include one or more forward osmosis membrane materials of the present disclosure. The forward osmosis membrane can have a first layer exhibiting an average pore size between about 0.1 nm and about 1 nm, and/or a second layer exhibiting an average pore size between about 0.02 μm and 1 μm. The forward osmosis membrane can at least partially reject one or more target substances, such as one or more substances having an average size of about 1 nm or greater. Accordingly, the forward osmosis membrane is capable of receiving a feed stream, such as a feed stream including water, and forming a purified stream. The hydrogel material 270 can receive the purified stream and can form a fertigation product stream. Importantly, hydrogel material 270 can be used to draw the liquid across/through membrane 260.

Hydrogel material 270 can include a hydrogel material of the present disclosure. Example liquid flow direction 280 is shown in FIG. 2B, As shown, liquid can pass through at least a portion of membrane 260 prior to contacting hydrogel material 270. In one example, membrane 260 is positioned adjacent to hydrogel material 270. In another example, at least a portion of membrane 260 is positioned in contact with at least a portion of hydrogel material 270. In one example, membrane 260 and hydrogel material 270 can be positioned such that the weight of the feed liquid can be used to promote extraction of liquid from hydrogel material 270. Therefore, membrane 260 can be positioned on top of hydrogel material 270, such as within a fluid transport conduit. Each of the membrane 260 and the hydrogel material 270 can be present in one or more layers.

Hydrogel material 270 can be infused with one or more fertilizers of the present disclosure. In one example, hydrogel material 270 can be promote drawing water across and/or through membrane 260. The water can then be transferred across and/or through hydrogel material 270. By transferring water across and/or through membrane 260 and hydrogel material 270, water can be at least partially purified (e.g., partially desalinated) by membrane 260 to form a purified stream, and infused fertilizer can be transferred from hydrogel material 270 to the purified stream to form a fertigation product stream for irrigation and/or fertilization (e.g., diluted fertilizer product stream). Therefore, the fertigation product stream can include one or more fertilizers of the present disclosure. System 250 can further include fluid transport tubing, pump(s), valves, vessels, inlet conduit, and outlet conduit. For example, the membrane 260 and/or hydrogel material 270 can be positioned within a fluid transport tube.

Importantly, hydrogel materials of the present disclosure can be efficiently synthesized for various applications. For example, hydrogel materials of the present disclosure can be used to draw water in forward osmosis applications, reducing or removing the use of liquid pumps. Therefore, the hydrogel material can at least partially promote drawing of water. In one example, the hydrogel material can be used in fertigation without the need for a separate draw solution. Managing two separate liquid streams (i.e., a feed water and a concentrated fertilizer draw solution) can be inefficient and complicated. Often, these draw solutions require a pump. The compositions of hydrogel materials can promote increased water flux, at least in part due to the improved hydrophilicity of the materials. These hydrogel materials can efficiently draw water across/through a forward osmosis membrane and can form a diluted fertilizer product stream by transferring at least a portion of fertilizer from within and/or on the hydrogel material to the liquid.

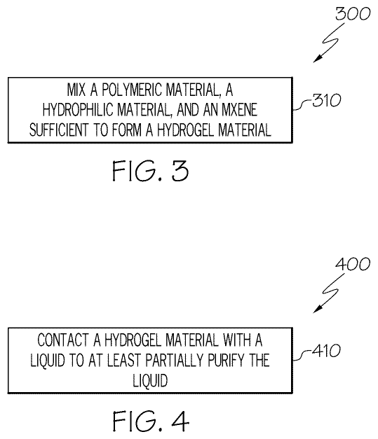

FIG. 3 illustrates a method for forming a hydrogel, according to some embodiments, Method 300 includes Step 310.

Referring to Step 310, a polymeric material, a hydrophilic material, and a MXene are mixed. Mixing can include placing in close physical proximity, dispersing, contacting, stirring, and/or heating. Mixing can be performed for more than 30 seconds, more than 2 minutes, or more than 5 minutes. The polymeric material, hydrophilic material, and the MXene can be mixed in various orders. In one example, the polymeric material, hydrophilic material, and MXene are mixed simultaneously. In another example, the hydrophilic material and MXene are mixed in a liquid before adding polymeric material. The mixture can be contacted with a basic liquid (discussed in further detail herein).

The polymeric material includes a plurality of polymers. The polymeric material can include an anionic polymer. The polymeric material may include an anionic polymer with a negative charge in a water solution. Examples of anionic polymers include polyacrylic acid and methacrylic acid. For example, the polymeric material can include polyacrylic acid (PAA), and/or derivatives thereof. Many side chains of anionic polymers such as polyacrylic acid may be deprotonated and display a negative charge. Anionic polymers such as deprotonated polyacrylic acid can absorb and retain water. Further, anionic polymers such as deprotonated polyacrylic acid can enhance the overall chemical potential of the hydrogel. Anionic polymers such as polyacrylic acid may exhibit a chemical potential and can assist in drawing water across the hydrogel.

The hydrophilic material includes one or more components capable of improving the hydrophilicity of the formed material. Hydrophilic substances are attracted to water and can increase water draw. The hydrophilic material can include one or more of nanosheets and nanoparticles. The nanosheets and nanoparticles can include negatively charged nanosheets and nanoparticles. For example, the hydrophilic material may include graphene oxide nanoparticles. In addition, or alternatively, the hydrophilic material may include graphene oxide nanosheets. Graphene oxide nanosheets can be exfoliated. Graphene oxide nanoparticles and/or nanosheets may be utilized due to the hydrophilic nature of the nanomaterial and the ease of dispersing the nanomaterial in an aqueous medium. Graphene oxide nanosheets can increase the hydrophilic functional sites and increase the connectivity in the hydrogel. Utilizing graphene oxide nanosheets in the hydrogel can provide increased structured channels for water flow. Importantly, these graphene oxide nanosheets can enhance the water draw capability without compromising the physical strength of the hydrogel.

Graphene oxide can be prepared using a modified Hummers method. In one example, sulfuric acid can be cooled, and graphite flakes and sodium nitrate can be added to the cooled sulfuric acid to form a solution. After, potassium permanganate can be added to the solution. The solution can be stirred and transferred to an ice bath. After, deionized water can be added, and the solution can be stirred at room temperature. Then, deionized water can be added to the solution followed by the dropwise addition of hydrogen peroxide. The solution can be vacuum filtered and washed, and the recovered graphite oxide cake may be washed with hydrochloric acid solution and vacuum filtered again. The mud can then be washed with deionized water until the pH rises. Finally, the graphite oxide may be diluted with deionized water and exfoliated with a probe ultrasonicator to produce graphene oxide nanosheets. Accordingly, the hydrophilic material can include exfoliated graphene oxide nanosheets.

The hydrophilic material can be added in the form of a dispersion. For example, the dispersion can include a graphene oxide dispersion. In one example, a graphene oxide dispersion with a concentration ranging from 1 g/L to 50 g/L is utilized. In another example, a graphene oxide dispersion with a concentration ranging from 5 g/L to 15 g/L is utilized. In yet another example, a graphene oxide dispersion with a concentration of about 10 g/L is utilized.

The MXene material includes a two-dimensional material including a transition metal. In one example, the MXene includes a two-dimensional (2D) inorganic material including a transition metal carbide, nitride, or carbonitride. The MXene material can include a material following the formula: Mₙ₊₁Xₙ. In the previous formula, M can include an early transition metal, X can include Carbon and/or Nitrogen, and n ranges from 1 to 4. The early transition metal can include at least one of Scandium, Titanium, Vanadium, Chromium, Manganese, and Niobium. In one non-limiting example, the early transition metal includes Titanium. In one example, the MXene material includes a mono transition MXene, such as M₂C, M₃C₂, and M₄C₃. In another example, the MXene material includes a double transition MXene, such as M′₂M″C₂ or M′₂N″₂C₃ where M′ and M″ are different transition metals.

The MXene material can include one or more surface terminations, sufficient for the MXene to follow the formula: Mₙ₊₁XₙTₓ. T can include a surface termination (e.g., O, OH, F, and/or Cl). In some embodiments, Tₓ is not present. The MXene material can exhibit a negative charge to contribute to the filtering capacity of heavy metals by at least a contribution of enhanced charge density. The MXene material can promote decomposition of organics and/or heavy metals in a liquid stream, such as a water-containing stream. The MXene material can contribute to the overall filtering capacity of the hydrogel material. In one example, the MXene material can be subjected to sonication and/or exfoliation prior to adding to the mixture. In another example, the MXene material is dispersed in water prior to addition to the mixture. In one example, 0.05 g to 0.5 g of MXene is dispersed in 5 mL to 20 mL of water. In another example, 0.1 g to 0.5 g of MXene is dispersed in 5 mL to 30 mL of water. The MXene can be dispersed in the form of a solution.

One or more water-soluble polymers can be added during the hydrogel formation process. The water-soluble polymer includes an organic polymer capable of dissolving, swelling, or dispersing in water. In one example, the water-soluble polymer includes chitosan. Chitosan has favorable biocompatibility, biodegradability, and nontoxicity. Chitosan includes at least one of chitosan and a chitosan derivative. Chitosan includes deacetylated chitin, a linear polysaccharide of deacetylated beta-1,4-D-glucosamine. Examples of chitosan derivatives include carboxymethyl chitosan (CMCH), hydroxybutyl chitosan (HBC), and N,N,N-trimethyl chitosan (TMC), In one example, chitosan derivatives can be prepared by chemical modification to improve water solubility. In another example, the solubility of chitosan can be increased by introducing a group (e.g., hydrocarbyl, carboxymethyl, acyl, or sulfo group) on the amino or hydroxyl group.

Chitosan can be added to assist in hydrogel formation, by absorbing and/or retaining water. Chitosan can be added to promote hydrophilicity to the hydrogel product. Improving the hydrophilicity can improve the water permeation rate and anti-fouling properties of the hydrogel in water filtration applications. In one example, since chitosan is a water-soluble polymer, chitosan exhibits excellent compatibility with graphene oxide materials, since these graphene oxide materials can be water-based. Chitosan can be added in the form of a chitosan solution. In one example, a chitosan solution is formed by mixing acetic acid (e.g., 10% acetic acid) and chitosan. The hydrophilic material and the MXene material can be added to the chitosan solution. Simultaneously, or after, the polymeric material can be added and mixed.

Components used in method 300 can be added in various orders. In one non-limiting example, an MXene material dispersion and a hydrophilic material (e.g., including graphene oxide) dispersion are added to a chitosan-containing solution to form a first mixture. Simultaneously, or after, a polymeric material, such as polyacrylic acid, can be added to the first mixture to form a second mixture. The polymeric material can be stirred to obtain substantial homogeneity of the second mixture. The second mixture can be contacted with a basic solution, such as a sodium hydroxide solution. Hydrogel beads can form by contacting the second mixture with the basic solution. The formed beads can be rinsed with a liquid, such as water. The formed beads can be stored in water.

Hydrogel materials of the present disclosure can be formed by method 300. Hydrogel materials can include at least one of chitosan, a chitosan derivative, a polymeric matrix (e.g., including polyacrylic acid), an MXene, and a hydrophilic material. Hydrogel materials formed by method 300 can be in the form of hydrogel beads. The hydrogel beads can have an average bead diameter ranging from about 0.1 mm to about 20 mm. The hydrogel beads can have an average bead diameter ranging from about 0.1 mm to about 5 mm.

In one example, hydrogel materials of the present disclosure include chitosan, polyacrylic acid, a MXene material, and graphene oxide. In one non-limiting example, hydrogel materials of the present disclosure include chitosan, polyacrylic acid, a titanium-containing MXene material, and graphene oxide nanosheets. Hydrogel materials herein can be used for liquid purification/separation applications. For example, these hydrogel materials can be used for heavy metal purification. Heavy metal purification systems can include hydrogel materials of the present disclosure. After heavy metal purification, the hydrogel material can be regenerated (e.g., contacting and/or soaking with sodium chloride or hydrogen peroxide).

FIG. 4 illustrates a method for purification, according to some embodiments. Method 400 includes Step 410.

Referring to Step 410, a hydrogel material is contacted with a liquid to at least partially purify the liquid. Contacting can include placing in physical contact, flowing the liquid past the hydrogel material, and/or mixing. Contacting can include immersing the hydrogel material in the liquid. Contacting can be conducted for a period of time sufficient for at least partial purification of the liquid. The hydrogel material includes hydrogel materials of the present disclosure. In one example, the hydrogel material includes a polymeric matrix, a MXene material, and graphene oxide. In another example, the hydrogel material includes a polymeric matrix (e.g., including polyacrylic acid), a MXene material, chitosan, and graphene oxide. The liquid can include water.

Step 410 can be utilized for purifying a liquid including one or more heavy metals. Step 410 can be sufficient for adsorption of the one or more heavy metals on the hydrogel material. In one example, the one or more heavy metals include metal ions. Heavy metal ions are significant pollutants in water resources because of their widespread release from various industries such as metallurgy, mining, batteries, textile dyeing, and printing. These ions are typically highly toxic and non-biodegradable, posing severe threats to ecosystems. The one or more heavy metals can be selected from Lead, Mercury, Chromium, Silver, Copper., Cadmium, Nickel, Barium, Zinc, Iron, Arsenic, and salts and/or ions thereof. The heavy metals can include at least two of Lead, Mercury, Chromium, Silver, Copper, Cadmium, Nickel, Barium, Zinc, Iron, Arsenic, and ions thereof. In one example, the one or more heavy metals include at least one of Nickel (e.g., Ni²⁺ ions) and Copper (e.g., Cu²⁺ ions). The one or more heavy metals can be present as a salt compound, such as CuCl₂ or NiCl₂.

The initial concentration of heavy metals in the liquid can vary depending on the liquid source. In one example, the concentration of heavy metals in the liquid ranges from about 0.001 mg/L to about 1000 mg/L. In another example, the concentration of heavy metals in the liquid ranges from about 0.01 mg/L to about 600 mg/L. In another example, the concentration of heavy metals in the liquid ranges from about 0.1 mg/L to about 100 mg/L. In another example, the concentration of heavy metals in the liquid is greater than about 0.1 mg/L In another example, the concentration of heavy metals in the liquid is greater than about 10 mg/L.

The hydrogel material can exhibit a heavy metal adsorption percentage of greater than 70%. In one example, the hydrogel material can exhibit a heavy metal adsorption percentage of greater than 80%. In another example, the hydrogel material can exhibit a heavy metal adsorption percentage of greater than 90%. In another example, the hydrogel material can exhibit a Copper adsorption percentage of greater than 90%. In another example, the hydrogel material can exhibit a Nickel adsorption percentage of greater than 70%. In another example, the hydrogel material can exhibit a Nickel adsorption percentage of greater than 80%. Heavy metal adsorption percentages of metals of the present disclosure can refer to the metal ions.

In one example, the inclusion of MXene in the hydrogel material can promote an enhanced heavy metal adsorption capacity. For example, the hydrogel material can exhibit a Cu²⁺ adsorption capacity of greater than about 1 mg/g. In one example, the hydrogel material can exhibit a Cu²⁺ adsorption capacity of greater than about 1.5 mg/g. The hydrogel material can exhibit a Ni²⁺ adsorption capacity of greater than about 0.75 mg/g. In one example, the hydrogel material can exhibit a Ni²⁺0 adsorption capacity of greater than about 1 mg/g. In another example, the hydrogel material can exhibit a Ni²⁺ adsorption capacity of greater than about 1.1 mg/g.

The hydrogel material can be regenerated after heavy metal adsorption. Regeneration can be carried out by soaking the hydrogel material in a liquid, Regeneration can at least partially remove one or more heavy metals from one or more surfaces of the hydrogel material. In one example, the hydrogel material is regenerated with sodium chloride or hydrogen peroxide. The hydrogel material can be rinsed with water (e.g., DI water) after regeneration. Accordingly, Step 410 can be repeated for one or more times after regeneration.

Importantly, hydrogel materials of the present disclosure can be used for heavy metal removal via adsorption. For example, these hydrogel materials are capable of removing one or more heavy metals (of varying concentrations) from a fluid stream, such as water-containing fluid streams. These hydrogel materials can promote multilayer adsorption and are capable of repeated use, since these hydrogel materials promote desirable adsorption even after regeneration and reuse. In one example, these hydrogel materials are capable of adsorbing at least one of copper (e.g., copper ions) and nickel (e.g., nickel ions) in water treatment applications.

### Example 1—PAA-Alginate-GO Hydrogels and Fertigation

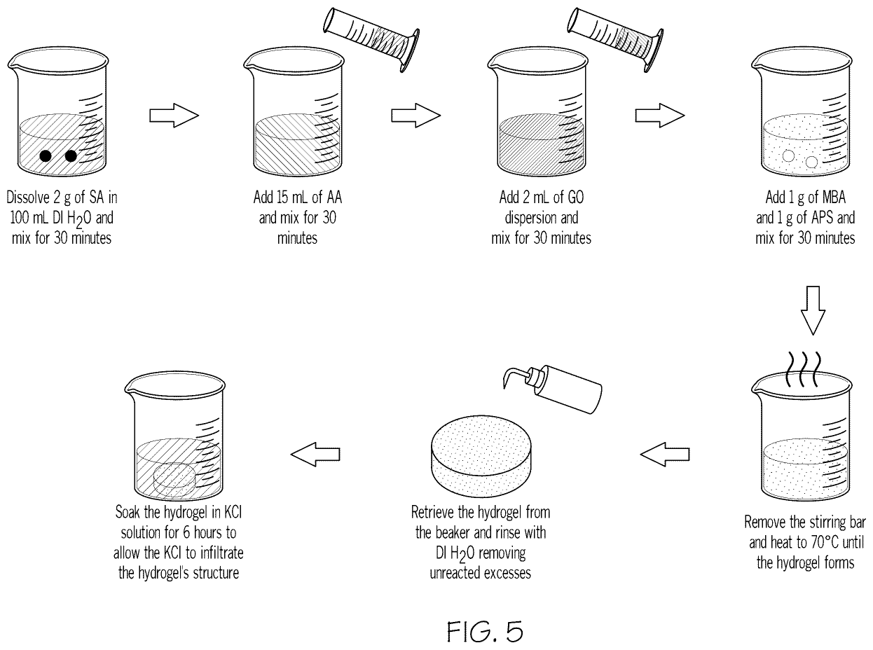

FIG. 5 illustrates an example method for forming a hydrogel, according to some embodiments. Graphene oxide (GO) was synthesized using the modified Hummer's method. The following procedure was used to prepare the PAA-Alginate-GO (PAG) hydrogel: a 500 mL beaker was filled with 100 mL of DI H₂O, then 2 g of sodium alginate (SA) was added to the beaker and stirred at 300 rpm for 30 minutes until the SA was completely dissolved. Then, 15 mL of acrylic acid (AA) solution was added and stirred for 15 minutes to ensure a complete mix. 2 mL of GO was added to the solution and stirred for 15 minutes till completely mixed. Afterward, 1 g of N,N′-Methylenebisacrylamide (MBA) was added to the samples to crosslink SA and AA, and 1 g of ammonium persulfate (APS) was added and mixed for 10 minutes to initiate the polymerization reaction of AA.

The mixtures were heated for 30 minutes at 70° C., and the hydrogel was formed and formed the shape of the beaker. The AA solution became Polyacrylic Acid (PAA) since it was polymerized with the initiator, and the alginate was set to form a hydrogel. After gel formation, the hydrogel was gently removed from the beaker and rinsed with DI H₂O from both sides to ensure that the residuals (e.g., materials that did not react) were washed away. The extracted hydrogels were cut at 5 cm diameter. After the synthesis process, the hydrogel was freeze-dried at −50° C. for 12 hours to expel some water from the polymeric matrix, increasing the salt concentration of the hydrogel and creating a higher osmotic gradient between the feed and the hydrogel for a higher water flux. The PAG hydrogel can be infused with a KC solution, allowing KCl to infuse into the hydrogel structure, leading to an increase of the hydrogel salt content. Therefore, the infused hydrogel possessed significant osmotic potential that was much higher than feeds, such as groundwater.

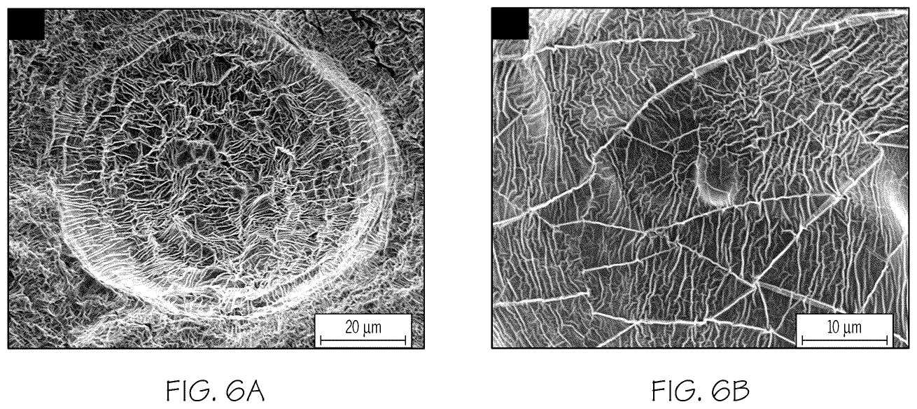

FIG. 6A illustrates a scanning electron microscope (SEM) image of a FAG hydrogel, according to some embodiments. In FIG. 6A, the scale is shown for 20 μm. FIG. 6A shows a well-defined structure, which can be attributed to the incorporation of GO; since GO nanosheets are flexible, they can modify the polymeric matrix's structure, impacting the hydrogel's water retention abilities, FIG. 6B illustrates a scanning electron microscope (SEM) image of a PAG hydrogel, according to some embodiments. In FIG. 6B, the scale is shown for 10 μm. By taking a magnified look at the sample in, the GO may alter the polymeric chain orientation and packing; here, clearer channels can be seen, indicating a more well-defined matrix and showing the potential for water to travel through these channels, lessening the potential to be trapped in the hydrogel matrix.

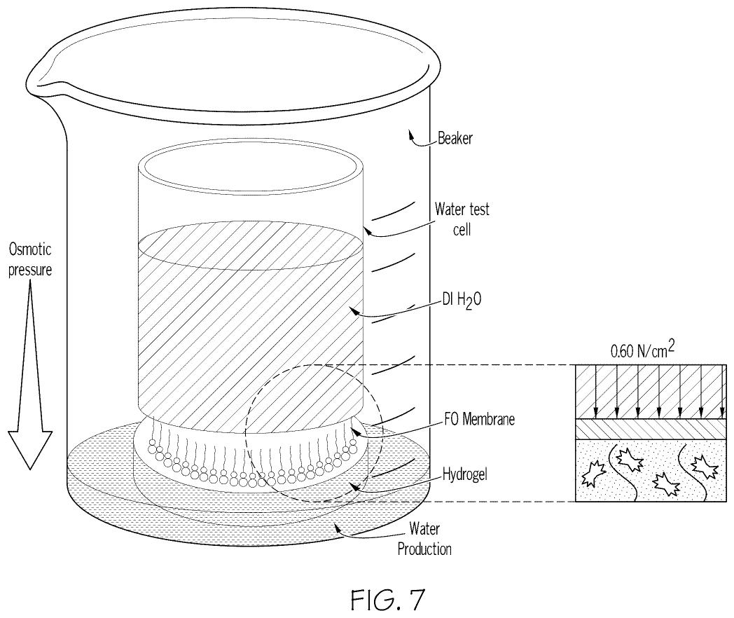

FIG. 7 illustrates an example fertigation test, according to some embodiments. The water tests took place using two different feed solutions: DI water and a groundwater (GW) sample with an average salinity of 274.5 mg/L (conductivity of 549 μS/cm²) at room temperature (e.g., about 20° C.)., Initially, the synthesized hydrogel was freeze-dried at −50° C. for 12 hours and weighed to obtain its before experimental weight. Then, it was immersed in 0.5 M KCl solution for 12 hours, which allowed KCl to infuse into the hydrogel structure, increasing the salt content. The infused hydrogel possessed significant osmotic potential—much higher than the feed solution of groundwater. This hydrogel's preparation and regeneration process was repeated in fertigation tests for both DI water and groundwater feed for consistency in each test. Before the water test, the FO membrane was cleaned by soaking the membrane in DI water for 1 hour. Then, the membrane was installed in between the feed water compartment and collected water compartment of the water test cell, as illustrated in FIG. 7. The hydrogel performance as a draw agent was expressed in terms of water flux, which was calculated using the following Equation 1:

$${J}_{w} = \frac{{W}_{p}}{{ρ}_{w} A t} \qquad ( 1 )$$

Where J_{w} (LMH) is the water flux through the FO membrane, Wₚ (g) is the weight of the water in the beaker after the dewatering process is completed, ρ_{w} is the water density (≈1 g/mL), A is the contact area between the membrane and the hydrogel is circular (≈4.91 cm²), and t is the time of the test, which was 24 hours.

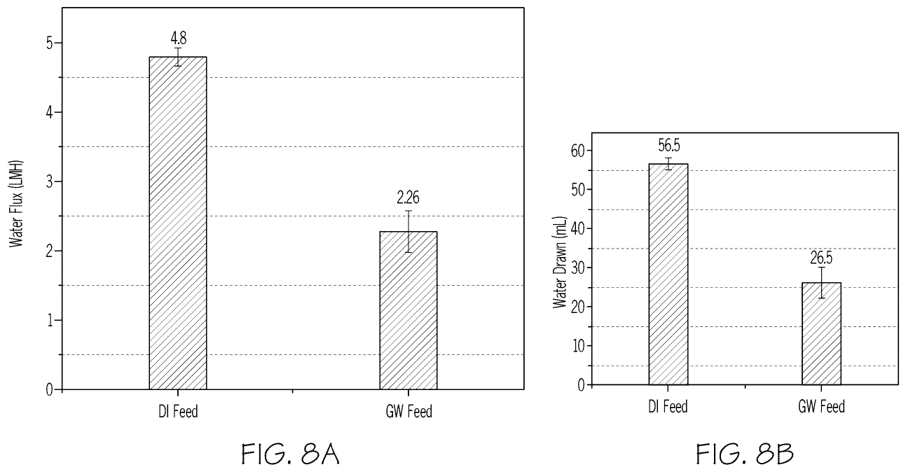

FIG. 8A illustrates PAG hydrogel performance in terms of water flux, according to some embodiments. FIG. 8B illustrates PAG hydrogel performance in terms of water flux, according to some embodiments. The water flux of the DI water feed was higher than the GW feed since the osmotic gradience between the feed and the hydrogel was higher, whereas the GW feed had lower osmotic gradience. In FIG. 8A, when the DI feed was used, the water flux was about 4.80 LMH, corresponding to 56.5 mL of water drawn across the FO membrane. When the GW feed was used, the water flux was almost halved at 2.26 LMH, corresponding to 26.5 mL of water drawn across the FO membrane, as shown in FIG. 8B.

The salinity of the diluted fertilizer (KCl) solution when the DI feed was used was approximately 5500.0 mg/L (conductivity of 11.0 mS/cm), while the concentration of diluted fertilizer solution when the GW as feed was 10875.0 mg/L (conductivity of 21.75 mS/cm). The difference between the conductivity of the two water products can be attributed to: when DI feed was used, more water was available in the beaker, diluting the KCl concentrations within the hydrogel. The molar concentrations of diluted fertilizer solution from the GW feed was equivalent to 0.14M KCl. This was within the recommended concentration range of fertilizer solution for healthy crop irrigation. This shows that the PAG hydrogel can be efficiently used for the FO fertigation application.

Importantly, regenerative PAA-alginate-GO (PAG) hydrogels were utilized for obtaining water through FO membranes in a sustainable manner, e.g., no external stimuli or energy input was required. For example, the hydrogels were synthesized using crosslinking polymerization and used as draw agents in forward osmosis. In one example, the cross-linked PAA clusters dissociated into polyacrylate anions while remaining part of the hydrogel wall structure, generated osmotic potential and allowed the hydrogels to draw more water. The alginate content within the hydrogels provided the gel skeleton, which held high water content. The GO nanosheets within the hydrogel contributed to restructuring the polymeric matrix into more organized vertical chains, allowing easy water passage. Hence, this hydrogel draw agent exhibits a dewatering approach that, in some embodiments, does not require an external energy source. Further, the present disclosure illustrates a fertilizer infused hydrogel to desalinate groundwater for the purpose of fertigation.

### Example 2—PAA-Alginate-GO Hydrogels and Fertigation Comparison

4 g SA was dissolved in 200 mL and was mixed for 20 minutes. Then, 10 mL of AA was added to the SA solution and mixed for 20 minutes for solution homogeneity. Then, the optimization of the MBA and APS content was carried out by adding them into 3 hydrogel mixtures (H1: 0.50 g MBA+0.25 g APS, H2: 0.75 g MBA+0.50 g APS, H3: 1.00 g MBA+0.75 g APS). Each mixture was heated up to 70° C. and was left for some time to form the hydrogels. It was observed that the H1 hydrogel formed the slowest (21 minutes) in comparison to H2 (17 minutes) and H3 (13 minutes), indicating that the more the content of the initiator, the faster its response to the heat and the faster the formation of the hydrogel will be. After retrieving the 3 hydrogels, they were rinsed with DI water to remove any excessive materials that did not react. Then, they were tested for DI water production. The DI water production tests indicated that the H1 hydrogel had the highest DI water production; hence, among the 3 hydrogels, H1 was chosen for the next phase (i.e., with GO).

The H1 mixture was used since its hydrogel had the highest DI water production. Two H1 mixtures were prepared, and 2 different amounts of GO were added to formulate 2 hydrogels (HG1: 2 mL GO, HG2: 4 mL GO). After retrieving the hydrogels, they were used in the DI water production test. In the DI water production test, the feed used was DI water, and the hydrogel was used after it was rinsed right after the synthesis process. The water test cell included 2 compartments connected together with bolts. The FO membrane was installed between these compartments, and the cell was put on top of the hydrogel in a large beaker to collect the extracted water. The cell design allows its weight, as well as the weight of the feed, to mechanically press the water out of the hydrogel (e.g., dewatering). The volume of the feed was 300 mL, and the weight of the cell was 300 g, indicating a total weight of 0.60 N/cm².

One purpose of implementing the DI water production test is to identify the hydrogel (among the H1, H2, H3, HG1, and HG2) with the best performance as a draw agent, to be used in the fertigation water production test. In the fertigation water production tests, the feed was groundwater, and the hydrogel was washed thoroughly to remove its inner salinity (i.e., Na⁺) and soaked in a fertilizer solution for 6 hours. Four fertilizer solutions were utilized: 0.5 M KCl, 1.0 M KCl, 0.5 M KNO₃, and 10 M KNO₃ to inspect the role of the fertilizer, as well as its concentration, on the performance of the hydrogels.

4 standard solutions per ion with the following concentrations: 50, 100, 200, and 400 mg/L were prepared to measure the hardness (Ca²⁺, Mg²⁺), the salinity (Na⁺), and the groundwater's KCl content before and after treatment. The salts used to prepare the standard solutions were CaCl, MgCl, NaCl, and KCl. While preparing the standard solutions, a few droplets of 1% HNO₃ solution were added to keep the metal ions from forming hydroxide or carbonate formations.

The synthesized GO nanosheets were characterized by SEM, XRD and FTIR analysis, where the synthesized GO nanosheets are characterized by their wrinkled and sheet-like structure; moreover, the oxidation of the graphite flakes introduced morphological distortions. The peak at 2θ=10.6° corresponds to the (0 0 2) crystalline plane found in GO nanosheets, confirming that the synthesis of GO nanosheets was successfully implemented. The successful oxidation of the graphite flakes was confirmed by observing some of the functional groups related to GO. The peak at 1036 cm¹ indicates the presence of a C—O bond that resulted from the stretching vibrations of the C—O—C functional group. The peak at 1619 cm⁻¹ is ascribed to C═C stretches from the unoxidized graphitic flakes. The 1723 cm⁻¹ peak is attributed to the C═O stretch of the carboxyl group. The absorption peak at 3236 cm⁻¹ corresponds to an O—H stretching due to the presence of a stretch in the carboxylic acid since there were absorbed water molecules.

For the characterization of hydrogels, the spectra exhibited a broad peak between 3700 and 3000 cm⁻¹, indicating O—H stretching vibrations. This peak confirms the presence of hydroxyl groups in alginate and PAA. The characteristic peak around 1786 cm⁻¹ corresponds to the C═O stretching vibration, primarily from the carboxylic acid groups of PAA and alginate. This peak is prominent across H1-H3 and HG1-HG2, but the reduced intensity in HG1 and HG2 indicates partial chemical interaction between the carboxyl groups and GO through esterification or hydrogen bonding. The peak at 1643 cmv represents the stretching vibrations of C═C bonds. This feature is stronger in HG1 and HG2, suggesting the presence of unsaturated carbon bonds within the GO sheets. The relative enhancement of this peak in HG1 and HG2 compared to H1-H3 signifies the successful incorporation of GO into the hydrogel matrix. The typical GO D-band and G-band were found in the HG1 and HG2 samples at 1345 cm and 1589 cm⁻¹, respectively, indicating the successful incorporation of GO into the H1 hydrogel.

A peak was shown at 2933 cm⁻¹ and is a C—H stretching vibration commonly found in organic compounds. Its higher intensity in the HG1 and HG2 samples than the H1, H2, and H3 samples suggests changes in the molecular environment due to the interaction between the polymeric matrix and GO, which may be affecting the alignment of the hydrocarbon chains. Regarding swelling ratios, the H1, H2, and H3 hydrogels showed lower swelling ratios than the HG hydrogels. Moreover, HG1 and HG2 had the highest increment, indicating that the addition of GO has introduced many (—OH) functional groups. The H1 hydrogel had a swelling ratio of 20.5±0.50, followed by the H2 at 18.4±0.75, and H3 at 17.5±1, further confirming that the higher the content of the crosslinker and initiator within the hydrogel's mixture, the denser the hydrogel and the lower its absorption capacity. On the other hand, the highest swelling ratio was attributed to the HG1 hydrogel at 26.3±0.90, followed by the HG2 hydrogel at 22.3±0.43, Incorporating GO into the H1 hydrogel enhanced its absorption capacity by about 13.6%.

Among the 3 hydrogels, H1 performed the best, with a water production of 20±1.6 mL, which is almost 65% higher than 12 (13±2.1 mL) and 100% higher than H3 (10±1.6 mL), indicating that a higher content of the crosslinker and initiator could lead to a lower amount of water draw, Afterward, the mixture used to synthesize the H1 hydrogel was incorporated with GO in two different concentrations, fabricating HG1 and HG2. The DI water production of H16 was at 33±1.1 mL, surpassing the performance of HG2 (27±1.7 mL) by 19%. HG1 demonstrated the highest amongst all the tested hydrogels.

Regarding the fertigation testing, instead of a liquid draw solution, when the hydrogels were in contact with the osmotic membrane, they removed the water molecules from the membrane's pores since they have strong hydrophilicity. Hence, the membrane becomes less hydrophilic and has lower surface energy, whereas the hydrogels are hydrophilic and have higher surface energy; hence, there is an energy gradient between the membrane and hydrogels, providing the driving force responsible for the water transport.

The HG1 hydrogel was employed for the fertigation water production experiments. Before the tests, the hydrogels were soaked in different fertilizers (KCl and KNO₃) with high and low concentrations; then, two groundwater samples were used as feed. Regarding the results of using GW1 as feed and KCl as the concentrate fertilizer, it was noticed that when the hydrogel was soaked in 0.5 M KCl, it produced 37±1.5 mL, while when the concentration of KCl was doubled, the performance was 39±2.0 mL, showing that the increase in the concentration of the fertilizer used to infuse the hydrogel did not significantly improve the amount of water drawn. The same trend for GW2 was observed. On the other hand, when KNO₃ was used as concentrate fertilizer, although the fertigation solution was obtained successfully, less amount of fertigation solutions was generated than KCl. This is due to the fact that KCl has higher osmotic pressure than KNO₃ under the same conditions. This higher osmotic pressure could be since KCl has a higher solubility than KNO₃.

The fertigation solutions on the permeate side of the FO membrane of GW1 and GW2 samples were analyzed by ICP-OES to evaluate the removal of hardness ions and salinity. Na⁺ and Mg²⁺ were completely rejected (100% rejection) by the FO membrane for both GW1 and GW2 samples, and Ca²⁺ removal of 96.3% (for GW1) and 96.2% for (GW2) were achieved. In addition, the concentrations of K⁺ were measured in both feeds and in the fertigation solution, where the concentration of K⁺ in the fertigation water increased about 7.7 times (for GW1) and 8 times (for GW2) compared to the potassium ion concentration of in GW1 and GW2 before treatment. The molar concentrations of the diluted fertilizer solutions KCl and KNO₃ were 0.161 M and 0.150 M, respectively, in line with the desirable range of KCl and KNO₃ fertilizer requirements.

Accordingly, alginate-polyacrylic acid hydrogels H1, H2, and H3 were synthesized via chemical crosslinking, and the amount of crosslinker (MBA) and the initiator (APS) used in the synthesis were optimized based on the water production performance of hydrogels. The amount of crosslinker and initiator affected the gel-formation time and the water production performance; the higher the concentrations, the faster the formation time, the denser the hydrogel becomes, and the lower its water absorption capacity and draw. It was found that the H1 hydrogel, with 0.5 g MBA and 0.25 g APS, delivered better performance, producing 20±1.6 mL, which is 54% higher than H2 and 100% higher than H3. Two hydrogels were synthesized by adding different GO concentrations to the H1 mixture, named HG1 and HG2 hydrogels. In the DI water production experiments, HG1 performed better, with 33±1.1 mL water production, which is 22% higher than HG2. Prior to the fertigation process, the hydrogels were soaked in 0.5 M KCl, 1 M KCl, 0.5 M KNO₃ and 1.0 M KNO₃, respectively.

It was observed that the hydrogels soaked in the KCl solutions had a higher water draw compared to the ones soaked in KNO₃. Moreover, increasing the molar concentration of the KCl solution to 1 M did not show a significant water draw compared to the 0.5 M KCl solution. As for the groundwater desalination, the HG1-KCl-infused hydrogel drew the groundwater feed through the membrane, achieving 100% removal of Na²⁺ and Mg²⁺ ions for both GW1 and GW2 samples, 96.3 and 96.2% removal of Ca²⁺ from groundwater samples respectively. Moreover, the product water had gained about 8 times the KCl concentration than the GW feed, and the total concentration of fertilizers was desirable.

### Example 3—Polymeric Matrix Hydrogels with GO and MXene and Heavy Metal Adsorption

A chitosan solution was made by mixing quantities of 10% acetic acid and chitosan together. 0.2 g MXene was crushed with a mortar and pestle, followed by its exfoliation in 20 mL DI H₂O using a probe ultrasonicator. The dispersed MXene solution and 10 g/L GO dispersion were added to the chitosan solution, followed by continuous stirring. Then PAA was added to the solution and continuously stirred to attain homogeneity in the of the polymeric nanocomposite solution. A pipette dropper was used for the dropwise introduction of the polymeric nanocomposite solution into 400 mL 1 M NaOH. Hydrogel beads formed almost immediately. The beads were left in the 1M NaOH solution at room temperature for 24 hours to fully cure. Thereafter, the beads were recovered and thoroughly rinsed with DI H₂O to eliminate any residue of the precursor or curing compounds. Upon the completion of the washing process, the hydrogel beads were stored in DI water for later use,

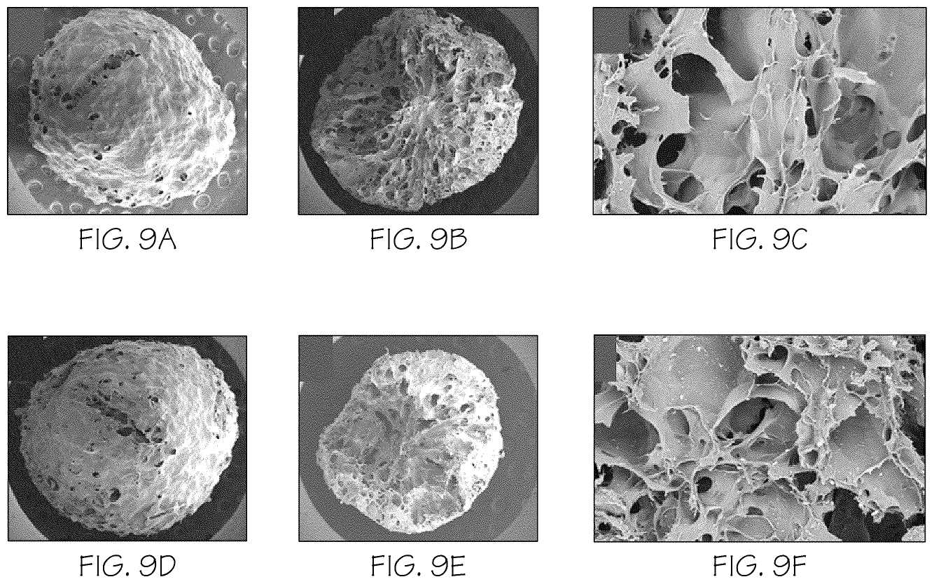

FIG. 9A illustrates a scanning electron microscope (SEM) image of a P hydrogel bead, according to some embodiments. FIG. 9B illustrates a scanning electron microscope (SEM) image of a cross-section of a P hydrogel bead, according to some embodiments. FIG. 9C illustrates a scanning electron microscope (SEM) image of a cross-section of a P hydrogel bead, according to some embodiments. The P hydrogel beads included a pure chitosan/polyacrylic acid hydrogel bead (P), but did not include GO or MXene.

FIG. 9D illustrates a scanning electron microscope (SEM) image of a GM hydrogel bead, according to some embodiments. The GM hydrogel beads included GO and MXene. For example, a titanium-containing MXene was utilized. FIG. 9E illustrates a scanning electron microscope (SEM) image of a cross-section of a GM hydrogel bead, according to some embodiments. FIG. 9F illustrates a scanning electron microscope (SEM) image of a cross-section of a GM hydrogel bead, according to some embodiments. The addition of GO and MXene to the GM beads has led to noticeable differences, both in physical appearance and in texture. Compared to the P hydrogel beads, the GM beads exhibit speckled features, as shown in at least FIG. 9F. These speckled features can be attributed to the nanomaterials integrated into the framework,

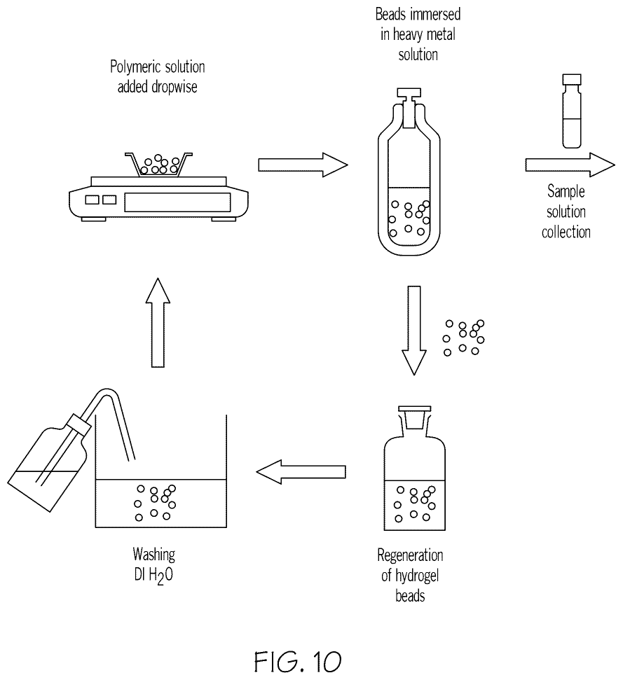

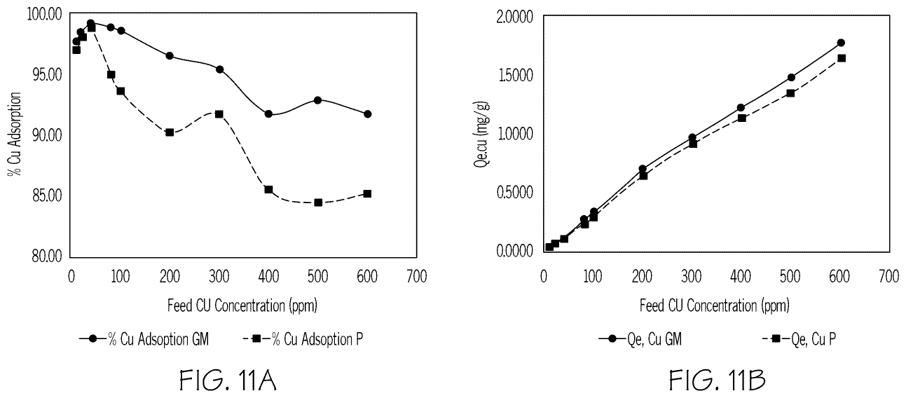

FIG. 10 illustrates an example heavy metal removal test, according to some embodiments. Briefly, 3 g of each type of hydrogel was soaked in 10 mL of representative heavy metal solutions (CuCl₂ or NiCl₂) for 24 hours at room temperature. The concentrations used for either type of heavy metal solution were 10, 20, 40, 80, 100, 200, 300, 400, 500, and 600 ppm (mg/L), After the batch adsorption experiments, the solution samples were collected and analyzed using an Inductively Coupled Plasma Optical Emission Spectroscopy (ICP-OES) analyser. The percentage removals and the equilibrium adsorption capacities were calculated using Equation 2 and Equation 3, respectively.

$$\% removal = \frac{{C}_{i} - {C}_{f}}{{C}_{i}} \times 100 \qquad ( 2 )$$

$$Q = \frac{{C}_{i} - {C}_{f}}{m} \times V \qquad ( 3 )$$

where Cᵢ (ppm) is the initial heavy metal concentration, C_{f} (ppm) is the final heavy metal concentration, m (g) is the mass of the wet hydrogel beads, and V (mL) is the volume of the heavy metal solution.

Regeneration of the hydrogel beads was carried out by soaking the spent hydrogel beads in either 1 M NaCl or 0.02 M H₂O₂ for 24 hours. For either regeneration route, the hydrogels were thoroughly washed after the regeneration time elapsed. Adsorption trials were then conducted by soaking the regenerated hydrogel beads in 500 ppm CuCl₂ (for the Cu²⁺ adsorption runs) and 500 ppm NiCl₂ (for the Ni²⁺ adsorption runs) for 24 hours. The Inductively Coupled Plasma Optical Emission Spectroscopy (ICP-OES) analyser was then used to measure the heavy metal concentrations of the solutions at the end of the adsorption trial. The % heavy metal removal and equilibrium adsorption capacities were then calculated according to Equation 2 and Equation 3, respectively. This regeneration procedure was carried out three times.

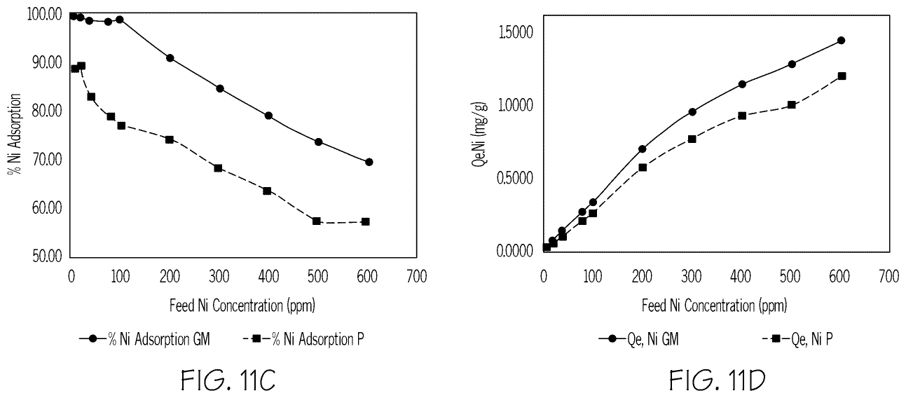

P and GM hydrogel beads were used to adsorb Cu²⁺ and Ni²⁺ ions from synthetic heavy metal solutions with initial concentrations of ranging from 10 to 600 ppm. FIG. 11A illustrates heavy metal removal results for P hydrogel and GM hydrogel beads based on percent copper adsorption, according to some embodiments. FIG. 11B illustrates heavy metal removal results for P hydrogel and GM hydrogel beads based on equilibrium copper adsorption, according to some embodiments. FIG. 11C illustrates heavy metal removal results for P hydrogel and GM hydrogel beads based on percent nickel adsorption, according to some embodiments. FIG. 11D illustrates heavy metal removal results for P hydrogel and GM hydrogel beads based on equilibrium nickel adsorption, according to some embodiments. At all the tested concentrations, the heavy metal removal was higher for the GM beads than for the P beads (FIG. 11A and FIG. 11C) The % removal values were higher for the Cu²⁺ than for Ni²⁺, suggesting that the synthesized beads may have a greater affinity for Cu²⁺ than for Ni²⁺. The equilibrium adsorption curves also displayed higher equilibrium adsorptions for the GM beads than for the P beads (FIG. 11B and FIG. 11D). Furthermore, higher equilibrium adsorption values were observed for the Cu²⁺ ions than for the Ni²⁺ ions.

Pure chitosan/polyacrylic acid hydrogel beads (P) and graphene oxide/MXene-incorporated chitosan/polyacrylic acid hydrogel beads (GM) were synthesized for heavy metal removal via adsorption. Adsorption tests with CuCl₂ and NiCl₂ solutions demonstrated that the synthesized hydrogel beads were able to successfully adsorb heavy metal ions (Cu²⁺ and Ni²⁺) from synthetic heavy metal solutions of different concentrations. The adsorption data from the tests were fitted with Langmuir and Freundlich adsorption isotherm models. For example, the coefficient of determination (R²) of the Freundlich model was found to be higher than that of the Langmuir model, suggesting multilayer adsorption mechanism in the synthesized hydrogel beads. The theoretical maximum Cu²⁺ and Ni²⁺ adsorption capacities of the P bead are calculated to be 0.941 mg/g and 0.667 mg/g, respectively—while the same for the GM beads were calculated to be 1.894 mg/g and 1.211 mg/g, respectively. In all the trials, the GM hydrogel beads had superior adsorption performance compared to the P hydrogel bead. The hydrogel beads were found to be suitable for repeated use, as favorable adsorption results persisted after regeneration and reuse. The GM hydrogel beads demonstrated excellent results for use as heavy metal adsorbent in water treatment applications.

Importantly, the incorporation of GO and MXene into a chitosan-PAA composite promoted adsorption efficiency and enhanced the performance of the polymeric composite beads. The synthesis of a graphene oxide-MXene-chitosan-PAA material in the hydrogel bead form exhibited enhanced adsorption capacity for heavy metals, such as copper and nickel ions. Therefore, hydrogel materials of the present disclosure can be efficiently utilized for industrial wastewater treatment, among other applications, at least in part based on the enhanced adsorption capacity of the hydrogel materials.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for fertigation, the system comprising:
a forward osmosis membrane capable of receiving a feed stream including water and at least partially rejecting one or more substances to form a purified stream; and
a hydrogel material capable of receiving the purified stream and forming a fertigation product stream, wherein the hydrogel material includes an alginate component, a polymeric matrix, and a graphene oxide material.

2. The system of claim 1, wherein the polymeric matrix includes polyacrylic acid, and the graphene oxide material includes graphene oxide nanosheets.

3. The system of claim 1, wherein the fertigation product stream includes at least one water-soluble potassium-based fertilizer.

4. The system of claim 1, wherein at least a portion of the hydrogel material is in contact with the forward osmosis membrane.

5. A method for fertigation, the method comprising:
adding a fertilizer to a hydrogel material, wherein the hydrogel material includes an alginate component, a polymeric matrix, and a graphene oxide material; and
transferring a liquid through the hydrogel material to form a liquid product stream, wherein the liquid product stream includes at least a portion of the fertilizer.

6. The method of claim 5, including drawing the liquid across a forward osmosis membrane material prior to transferring the liquid through the hydrogel material.

7. The method of claim 5, wherein the polymeric matrix includes polyacrylic acid, and the graphene oxide material includes graphene oxide nanosheets.

8. The method of claim 5, wherein adding the fertilizer to the hydrogel material includes infusing the hydrogel material with a fertilizer-containing liquid prior to transferring the liquid through the hydrogel material.

9. The method of claim 5, wherein the fertilizer includes at least one water-soluble fertilizer.

10. The method of claim 5, wherein the fertilizer includes a water-soluble potassium-based fertilizer.

11. The method of claim 5, further including regenerating the hydrogel material by adding additional fertilizer to the hydrogel material after transferring the liquid through the hydrogel material.

12. A method for forming a hydrogel, the method comprising:
mixing an alginate component, a hydrophilic monomer component, a cross-linking agent, an initiator, and a graphene oxide material sufficient for polymerization of the hydrophilic monomer component to form a hydrogel material.

13. The method of claim 12, wherein the alginate component includes at least one of alginate and sodium alginate.

14. The method of claim 12, wherein the hydrophilic monomer component includes acrylic acid.

15. The method of claim 12, wherein a weight ratio of the cross-linking agent to the initiator ranges from about 1.5:1 to about 2.5:1.

16. The method of claim 12, wherein the cross-linking agent includes N,N-methylene bisacrylamide (MBA), and the initiator includes ammonium persulfate.

17. The method of claim 12, wherein the graphene oxide material includes graphene oxide nanosheets.

18. The method of claim 12, wherein the alginate component, the hydrophilic monomer component, the cross-linking agent, the initiator, and the graphene oxide material are mixed simultaneously.

19. The method of claim 12, including forming the hydrogel material at a temperature of greater than about 50° C.

20. The method of claim 12, wherein the alginate component is present in first solution, the hydrophilic monomer component includes acrylic acid present in a second solution, and the first solution and second solution are mixed prior to mixing with the cross-linking agent and the initiator.
